(19) United States
(12) Patent Application Publication
(10) Pub. No.: US 2026/0135861 A1
(43) Pub. Date: May 14, 2026

(54) UNIFIED THREAT REMEDIATION

(71) Applicant: Abnormal AI, Inc., Las Vegas, NV (US)

(72) Inventors: Sanjay Jeyakumar, El Cerrito, CA (US); Abhijit Bagri, Atlanta, GA (US); Lucas Sonnabend, London (GB); Sanish Nandkumar Mahadik, Fremont, CA (US); Shoaib Ahmed, Bengaluru (IN); Maritza S. Perez, Sacramento, CA (US); Ivan Penev, New York, NY (US); Pranav Kumar Singh, Bangalore (IN)

(21) Appl. No.: 18/943,671

(22) Filed: Nov. 11, 2024

(51) Int. Cl. H04L 9/40; H04L 41/22

(52) U.S. Cl. CPC H04L 63/1416; H04L 41/22; H04L 63/1425

(57) ABSTRACT

A security threat associated with at least a first digital service platform for a user is detected. A plurality of digital service platforms associated with the security threat for the user are identified. Corresponding one or more remediation actions for each of the plurality of digital service platforms are determined. Each of the plurality of digital service platforms are interfaced with via a unified security platform to perform the corresponding one or more remediation actions for at least a portion of the plurality of digital service platforms.

### BACKGROUND OF THE INVENTION

Security systems can be deployed to protect computing systems from various threats that can compromise sensitive information or cause harm. When integrated to protect online cloud services, a security system can monitor the health of the online cloud service to detect and minimize potential cyber security threats. Example threats can include phishing attacks to trick users into revealing sensitive information, malicious software designed to exploit or harm a computing system or service, and distributed denial of service (DDoS) attacks to attempt to overload a computing system or service, among many others. Once a cyber security threat is detected, a remediation process can be performed to address and mitigate the impact of the detected threat. However, as organizations increasingly rely on online cloud services and as cyber threats become more prevalent and sophisticated, there is a need for improved and more comprehensive threat remediation solutions.

### BRIEF DESCRIPTION OF THE DRAWINGS

Various embodiments of the invention are disclosed in the following detailed description and the accompanying drawings.

FIG. 1 is a block diagram illustrating an embodiment of a computing infrastructure protected by a unified security platform capable of performing unified threat remediation.

FIG. 2 is a block diagram illustrating an embodiment of a unified security service for performing unified threat remediation across multiple digital service platforms.

FIG. 3 is a flow chart illustrating an embodiment of a process for performing unified threat remediation.

FIG. 4 is a flow chart illustrating an embodiment of a process for determining and applying threat remediation actions across multiple digital service platforms.

FIG. 5 is a flow chart illustrating an embodiment of a process for determining an ordering for performing remediation for digital service platforms.

FIG. 6 is a flow chart illustrating an embodiment of a process for applying remediation for a digital service platform.

FIG. 7 is a flow chart illustrating an embodiment of a process for providing remediation user interface views for multiple digital service platforms.

FIG. 8 is an example of a user interface view for displaying available remediation actions for different digital service platforms.

FIG. 9 is an example of a user interface view for a multiple digital service platform threat timeline.

FIG. 10 is an example of a user interface view for a multiple digital service platform threat remediation timeline.

FIG. 11 is a functional diagram illustrating a programmed computer system for performing unified threat remediation.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Unified threat remediation using a unified security platform is disclosed. For example, using the disclosed unified security platform, automatic remediation for security threats applied across multiple digital service platforms can be performed. Moreover, the remediation actions applied across the different digital service platforms can be performed in response to a detected security threat at any one of the multiple digital service platforms being monitored. For example, in the event a user account at a first digital service platform is compromised, remediation actions can be performed across all monitored digital service platforms for all potentially compromised accounts associated with the compromised user account. The ability to apply remediation actions across different digital service platforms from a unified source significantly reduces the response time when responding to a detected cyber security threat. Moreover, a unified response minimizes the impact of the detected threat including the likelihood of additional harm such as potential additional account takeovers of related accounts belonging to the same compromised user. In various embodiments, the unified security platform can correspond to a potential security threat detected at one monitored digital service platform to potential security threats at other corresponding digital service platforms, automatically applying the appropriate remediation actions for each different digital service platform. Since the different digital service platforms can differ in management and remediation features, the disclosed unified security platform determines the appropriate remediation actions to apply based on the target digital service platform.

In some embodiments, a security threat associated with at least a first digital service platform for a user is detected. For example, a security system, such as a unified security platform, monitoring multiple different digital service platforms for an organization, detects a security threat for one of the monitored platforms. The threat can be associated with a user of the organization such as with an account belonging to a user employed by the organization. An example threat can be associated with multiple failed login attempts for the user's account made from a suspicious location such as from a region where the organization does not have a presence and that the user is not known to visit.

In some embodiments, a plurality of digital service platforms associated with the security threat for the user is identified. For example, the different digital service platforms that are monitored for the organization and/or user are identified. The list of monitored digital service platforms is identified since a detected threat for the user on one platform can indicate that the other platforms are also under threat. For example, if a user email account is compromised then all services that utilize the user email account may also be compromised. In some embodiments, for each of the plurality of digital service platforms, corresponding one or more remediation actions are determined. For example, for each of the monitored digital service platforms, the appropriate remediation actions are determined. Although multiple of the monitored platforms may be similarly compromised, the appropriate actions to remediate the threat may be different depending on the platform. For example, for a first service platform, all existing sessions can be terminated for the compromised user account and the account can be suspended until an administrator can review the security scenario. In contrast, a second service platform may not support the suspension of accounts for administration review and instead all existing sessions can be terminated, and the compromised user account can be modified to require a password reset before another login can be performed.

In some embodiments, each of the plurality of digital service platforms is interfaced with via a unified security platform to perform the corresponding one or more remediation actions for at least a portion of the plurality of digital service platforms. For example, a unified security platform monitoring the different service platforms interfaces with each service platform to implement the appropriate remediation actions for that platform. The interface can be via an application programming interface (API) or another exposed mechanism for implementing remediation actions by an authorized source such as by a unified security platform. In some embodiments, the unified security platform logs into each service platform using the appropriate remediation account credentials before initiating the appropriate remediation actions.

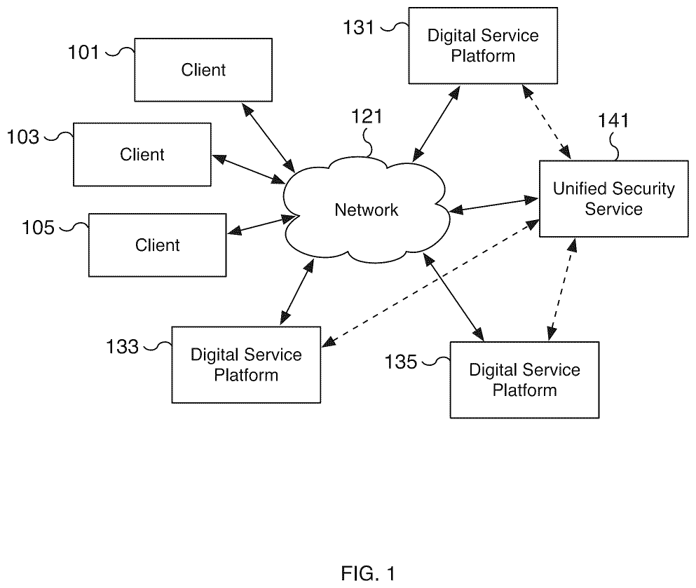

FIG. 1 is a block diagram illustrating an embodiment of a computing infrastructure protected by a unified security platform capable of performing unified threat remediation. In the example shown, clients 101, 103, and 105 are network clients configured to access digital service platforms 131, 133, and/or 135, and/or unified security service 141. Clients 101, 103, and 105 are communicatively connected to digital service platforms 131, 133, and/or 135, and/or unified security service 141 via network 121. Similarly, unified security service 141 is communicatively connected to digital service platforms 131, 133, and/or 135 via network 121. Network 121 can be a public or private network. In some embodiments, network 121 is a public network such as the Internet. In various embodiments, clients such as clients 101, 103, and/or 105 can access digital service platforms 131, 133, and/or 135, such as on behalf of an organization, using an assigned user account. Unified security service 141 monitors digital service platforms 131, 133, and 135 for security threats and in response to a detected threat at any one of digital service platforms 131, 133, and 135, performs a unified remediation response by applying the appropriate remediation actions for each of digital service platforms 131, 133, and 135.

In some embodiments, clients 101, 103, and 105 are each a network client device for interfacing with digital service platforms 131, 133, and/or 135, and/or unified security service 141. For example, clients 101, 103, and/or 105 can correspond to users of an organization configured to access cloud services offered by digital service platforms 131, 133, and/or 135. As another example, clients 101, 103, and/or 105 can correspond to information security personnel or other users with authorized security credentials that utilize unified security service 141 for performing security responsibilities, including cyber security threat mitigation, for an organization. In some embodiments, clients 101, 103, and/or 105 can further correspond to one or more malicious clients capable of threatening the security of digital service platforms 131, 133, and/or 135.

In some embodiments, digital service platforms 131, 133, and 135 correspond to different cloud-based services including web application services. For example, the digital services offered by the digital service platforms can include email services, messaging services, document creation and/or management services, identity services, product management services, cloud infrastructure services, enterprise resource planning services, customer relations services, and/or sales management services, among others. Three instances of digital service platforms are shown in FIG. 1 to represent the different services utilized by an organization. For example, a particular organization may subscribe to multiple different digital service platforms to meet their organization requirements rather than hosting the services and/or corresponding tools locally. In various embodiments, users can access the services offered by digital service platforms 131, 133, and 135 using a user identifier such as a username, user email address, and/or one or more other identifiers or forms of authentication. In some embodiments, the same user identifier, such as the same user email address or username, is used across the different digital service platforms 131, 133, and/or 135.

In some embodiments, unified security service 141 is a unified security platform for providing cyber security services including to protect monitored digital service platforms against cyber security threats by performing unified threat remediation. For example, unified security service 141 can be configured to monitor multiple different digital service platforms such as digital service platforms 131, 133, and 135 for security threats. Upon detection of a security threat at any one of the monitored digital service platforms, unified security service 141 can perform a unified approach to threat remediation. For example, unified security service 141 can apply the appropriate remediation actions to any of the monitored digital service platforms including at the digital service platform where an initial security threat is detected as well as any or all remaining monitored digital service platforms. In various embodiments, unified security service 141 can correlate the threat detected at one monitored digital service platform with potential threats to other monitored digital service platforms and apply the appropriate remediation actions to any impacted digital service platform. For example, the remediation actions applied at each of the monitored digital service platforms can be customized to the monitored digital service platform including based on what remediation features are available.

Although single instances of some components have been shown to simplify the diagram of FIG. 1, additional instances of any of the components shown in FIG. 1 may exist. For example, digital service platforms 131, 133, and/or 135 may be implemented by one or more digital service platform servers and unified security service 141 may be similarly implemented by one or more unified security service servers. Additionally, clients 101, 103, and 105 are example client devices. Although three clients are shown (clients 101, 103, and 105), many more additional clients can exist. Similarly, although three digital service platforms are shown (digital service platforms 131, 133, and 135), many more or fewer digital service platforms can be supported. In some embodiments, components not shown in FIG. 1 may also exist and/or the network configuration of the included components may differ from what is shown.

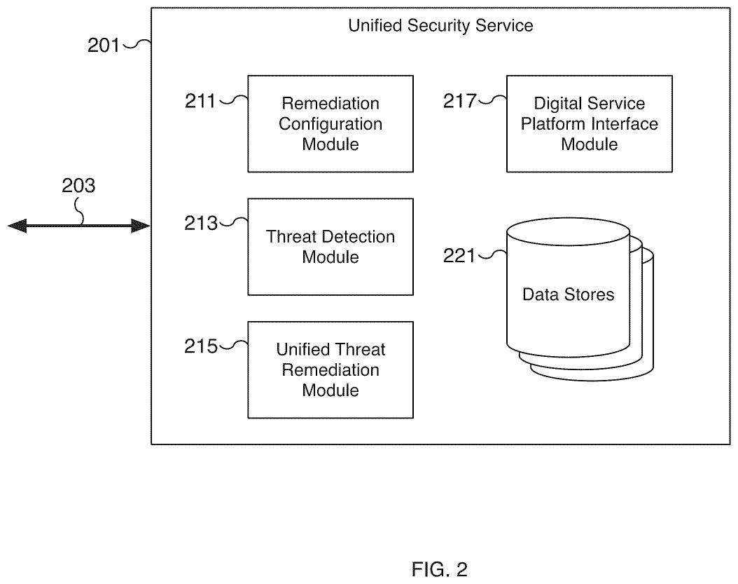

FIG. 2 is a block diagram illustrating an embodiment of a unified security service for performing unified threat remediation across multiple digital service platforms. In the example shown, unified security service 201 includes network connection 203, remediation configuration module 211, threat detection module 213, unified threat remediation module 215, digital service platform interface module 217, and data stores 221. In response to a detected security threat, unified security service 201 can initiate remediation actions to be performed at any and/or all digital service platforms monitored and/or managed by unified security service 201. In some embodiments, unified security service 201 is unified security service 141 of FIG. 1 and the digital service platforms protected by unified security service 201 correspond to digital service platforms 131, 133, and/or 135 of FIG. 1.

In some embodiments, network connection 203 is a network connection used by unified security service 201. Network connection 203 can be utilized by administrators to manage threat detection and unified threat remediation for multiple digital service platforms. On the detection of a security threat, network connection 203 is also used to interface with the different configured digital service platforms including to initiate remediation actions. For example, different modules of unified security service 201 can utilize network connection 203 for performing cyber security services for the configured digital service platforms.

In some embodiments, remediation configuration module 211 is a processing module for configuring remediation settings for different digital service platforms. For example, using remediation configuration module 211, the remediation actions available for a digital service platform can be determined and the appropriate remediation actions to take in the event of a security threat can be configured. In some embodiments, different remediation actions are taken depending on the security threat. For example, a high-risk threat can result in more severe remediation actions compared to a low-risk threat. In various embodiments, each digital service platform can be configured to respond differently including by determining which remediation actions to take and when to initiate remediation actions. For example, remediation actions can be configured to be performed only when the level of a detected security threat falls within a certain threshold, such as when a detected threat falls within a certain confidence and/or severity threshold.

In some embodiments, threat detection module 213 is a processing module for detecting cyber security threats. For example, using threat detection module 213, a security threat made against a digital service platform can be detected. In various embodiments, the detected threat includes a determined confidence score and/or severity score. For example, a confidence score can be determined that ranks how likely the detected threat is an actual threat. Similarly, a severity score can be determined that ranks the severity of the detected threat such as the amount of damage or harm that can result from the threat in the event that the threat is an actual threat. In some embodiments, threat detection module 213 may utilize one or more machine learning models including deep learning and/or large language models to identify potential cyber security threats and/or to determine corresponding scores such as a confidence score and/or severity score. Additionally, in various embodiments, one or more user accounts impacted by the security threat are determined. The impacted user accounts, corresponding scores, and/or other detected threat data can be provided to unified threat remediation module 215 to resolve, mitigation, and/or neutralize the security threat.

In some embodiments, unified threat remediation module 215 is a processing module for performing a unified approach to remediation for a detected security threat. For example, each configured digital service platform is analyzed to determine whether and how to address a security threat detected even if the threat is detected at only a single monitored digital service platform. Although the threat may be detected at only one digital service platform, all configured digital service platforms may be impacted by the threat and remediation is applied broadly in a unified manner.

In some embodiments, unified threat remediation module 215 retrieves configured remediation settings for each configured digital service platform. Using the retrieved settings, each digital service platform can be analyzed to determine whether its configured thresholds have been exceeded in order to automatically perform remediation actions on the digital service platform. For example, a digital service platform that manages highly sensitive and confidential information may have a low threshold set to initiate remediation actions that include disabling remote access. As another example, a digital service platform that is read-only and has only public data may require a high threshold to be exceeded in order to initiate remediation actions that include a required password reset. In various embodiments, unified threat remediation module 215 utilizes configured settings for each digital service platform and further utilizes digital service platform interface module 217 for interfacing with each digital service platform to perform remediation actions. In some embodiments, the remediation actions are performed automatically and do not require user intervention. In some embodiments, remediation actions are prepared but are initiated manually, such as by a security administrator. For example, a security administrator can configure whether remediation actions appropriate for a detected security threat should be performed automatically or manually.

In some embodiments, digital service platform interface module 217 is a processing module for interfacing with different digital service platforms. For example, digital service platform interface module 217 can utilize different application programming interfaces (APIs) or another access technique for accessing different digital service platforms. In some embodiments, other modules of unified security service 201 such as unified threat remediation module 215 utilize digital service platform interface module 217 to access remediation features for configured digital service platforms.

In some embodiments, data stores 221 are a collection of one or more data stores used by the different modules of unified security service 201. For example, data stores 221 can include a remediation configuration data store and be used to store digital service platform configurations including supported remediation services of monitored digital service platforms and the conditions required to initiate remediation actions. In some embodiments, data stores 221 store account information including the different accounts configured for a user for accessing different digital service platforms. As another example, data stores 221 can be used to store administrative and/or account credentials for interfacing with the remediation features of different digital service platforms. Data stores 221 can be further used to store security metrics, analytics, and reports including detected security threats and corresponding remediation results. Although not shown in FIG. 1, data stores 221 may be implemented with distributed data stores such as one or more distributed data stores accessed via network connection 203.

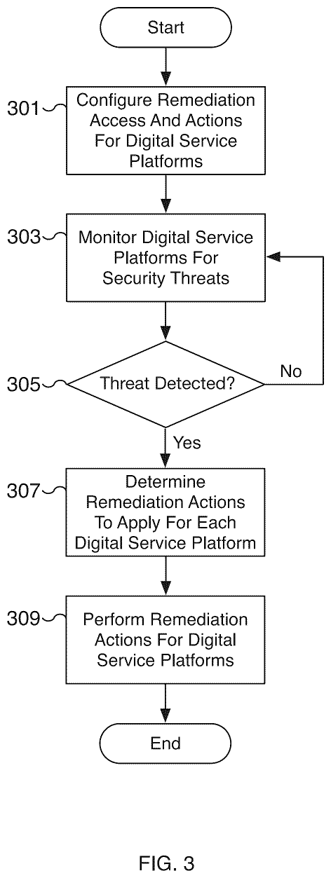

FIG. 3 is a flow chart illustrating an embodiment of a process for performing unified threat remediation. For example, using the process of FIG. 3, a unified security service can detect and uniformly address cyber security threats for all monitored digital service platforms when a cyber security threat is detected against one of the monitored digital service platforms. With this approach, potential and future cyber security threats can be resolved immediately by leveraging the early detection of a related cyber security threat. In some embodiments, the unified security service is unified security service 141 of FIG. 1 and/or the unified security service 201 of FIG. 2, and the monitored digital service platforms are digital service platforms 131, 133, and/or 135.

At 301, remediation access and actions for digital service platforms are configured. For example, one or more digital service platforms are configured for the monitoring and management of security threats. The configuration process can include setting remediation bands and/or thresholds that are required for initiating remediation actions for each managed digital service platform. In some embodiments, access privileges such as account credentials are configured. Additionally, the configuration process can further determine available remediation features and/or actions that are supported by each digital service platform and the appropriate actions to execute in the event of different detected threats or threat levels. Examples of available remediation actions can include: revoking a session, disabling an account, forcing a password reset, or suspending an account, among others.

At 303, digital service platforms are monitored for security threats. For example, each digital service platform configured at 301 is monitored for cyber security threats. Depending on the monitoring configuration, the security threats monitored for can include malware, viruses, unauthorized access, data breaches, denial-of-service attacks, scripting attacks, network scans, etc. In various embodiments, the different monitored digital service platforms can be accessed via access privileges configured at 301.

At 305, a determination is made whether a cyber security threat is detected. In the event a cyber security threat is detected, processing proceeds to 307. In the event a cyber security threat is not detected, processing loops back to 303 to resume monitoring of the digital service platforms.

At 307, the remediation actions to apply for each digital service platform are determined. For example, the appropriate remediation actions for each digital service platform configured at 301 are determined for the cyber security threat detected at 305. In various embodiments, based on the available remediation actions and features determined at 301, a configured threshold for initiating remediation is evaluated against the detected threat to determine whether and what remediation actions to perform for each digital service platform. For example, the remediation actions for a digital service platform may be determined only in the event that the threat's determined severity exceeds a configured required remediation threshold value for a digital service platform.

At 309, remediation actions for digital service platforms are performed. For example, the remediation actions determined at 307 to apply for each digital service platform are performed by remediation services of a unified security service. In some embodiments, the appropriate remediation actions are performed for each digital service platform and each platform may have different actions performed in response to the same detected threat. In some scenarios, based on configured remediation action thresholds, only a subset of the managed digital service platforms have remediation actions performed. For example, some digital service platforms may be configured to not perform remediation actions for threats that do not meet a required severity.

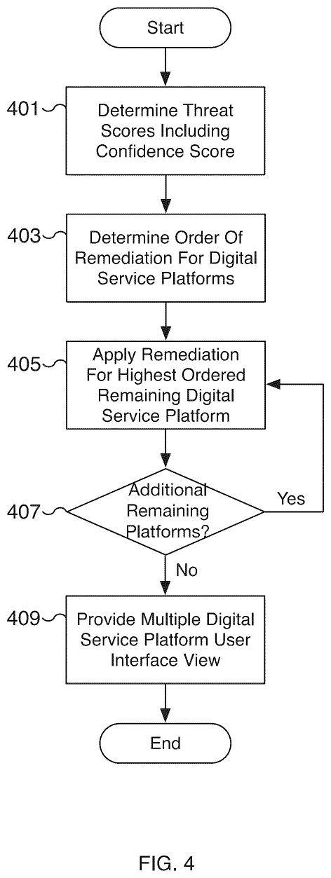

FIG. 4 is a flow chart illustrating an embodiment of a process for determining and applying threat remediation actions across multiple digital service platforms. For example, using the process of FIG. 4, a unified security service can apply remediation actions in response to a detected security threat. For example, a threat detected at one digital service platform can trigger the application of remediation actions across multiple digital service platforms. In some embodiments, the process of FIG. 4 is performed by a unified security service such as unified security service 141 of FIG. 1 and/or the unified security service 201 of FIG. 2 at 307 and/or 309 of FIG. 3. In some embodiments, the process of FIG. 4 is performed by a unified threat remediation module of a unified security service such as unified threat remediation module 215 of FIG. 2. In some embodiments, the digital service platforms monitored and to which threat remediation actions are applied are digital service platforms 131, 133, and/or 135.

At 401, threat scores are determined including a confidence score. For example, one or more scores to evaluate the detected security threat are determined including a threat confidence score. The threat confidence score can correspond to how likely the detected threat is a true threat and can be useful in eliminating and/or responding to potential false positives. In some embodiments, additional threat scores are determined such as a severity score. For example, a severity score can be determined that quantifies the severity of the impact created by the detected threat in the event the detected threat is an actual threat. Based on the determined severity score, different approaches to remediation can be taken for the different digital service platforms. In various embodiments, additional threat scores can be determined for the detected threat such as an expected downtime score, scope of impact score, vulnerability score, data leakage score, operations impact score, account exposure score, etc.

At 403, an order for remediation is determined for the digital service platforms. For example, the digital service platforms are ranked based on the detected threat and compared to one another to determine an order for performing remediation. In some embodiments, dependencies between the services are determined in order to set the order for applying remediation. For example, in the event an email account is compromised by a security threat and the email account is used for two-factor authentication, the email service may be prioritized for remediation. Similarly, digital services that utilized the email account will also be prioritized for remediation whereas digital services that do not use the email account will be ranked lower in the priority for remediation. In various embodiments, remediation can be performed based on priority with remediation performed first for the services with the highest priority. In some embodiments, remediation can be performed for multiple digital services in parallel, for example, if the services have the same priority ranking.

At 405, remediation is applied for the highest ordered remaining service platform. For example, based on the order for remediation determined at 403, the digital service platform with the highest ordering (or highest priority) is selected for remediation. In some embodiments, two or more services may share the highest ordering and the matching priority services can have remediation performed in parallel. Once selected for remediation, the appropriate remediation actions are applied for the selected digital service platform(s) based on the detected security threat. In some embodiments, the appropriate remediation actions are performed using a remediation interface exposed by the digital service platform. The digital service platforms with remediation applied at 405 are removed from the ordered list of services needing remediation and the ordered list contains only services that have yet to have remediation performed on them.

At 407, a determination is made whether additional digital service platforms remain that require remediation. In the event additional digital service platforms remain that require remediation, processing loops back to 405 where remediation can be applied for one or more of the remaining services. In the event no additional digital service platforms remain that require remediation, processing proceeds to 409.

At 409, a multiple digital service platform user interface view is provided. For example, a user interface view displaying remediation results is provided showing the actions performed for each digital service platform. In various embodiments, the user interface view can correspond to a dashboard, a summary such as an email summary, an interactive user interface, or another view that displays the results from performing unified threat remediation.

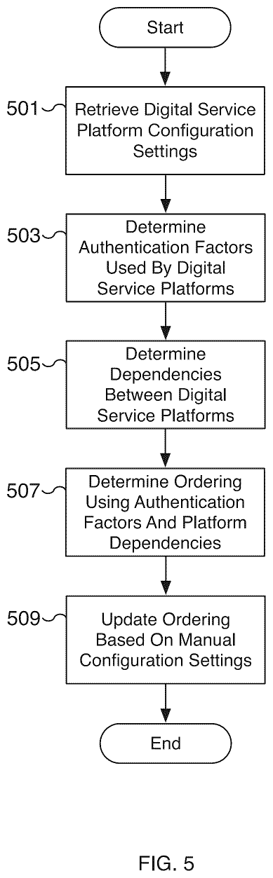

FIG. 5 is a flow chart illustrating an embodiment of a process for determining an ordering for performing remediation for digital service platforms. For example, using the process of FIG. 5, digital service platforms managed by a unified security service are analyzed to determine an order for applying remediation in the event a security threat is detected. The determined ordering can be based on the dependencies identified between the different digital service platforms. In some embodiments, the final ordering can be additionally configured manually by an administrator. In some embodiments, the process of FIG. 5 is performed by a unified security service such as unified security service 141 of FIG. 1 and/or the unified security service 201 of FIG. 2 at 307 and/or 309 of FIG. 3 and/or at 403 of FIG. 4. In some embodiments, the process of FIG. 5 is performed by a remediation configuration module of a unified security service such as remediation configuration module 211 of FIG. 2. In some embodiments, the digital service platforms analyzed for ordering are digital service platforms 131, 133, and/or 135.

At 501, digital service platform configuration settings are retrieved. For example, the configuration settings for monitored digital service platforms are retrieved. The retrieved settings can include access credentials as well as login and/or access pathways configured for users to access a digital service platform. The retrieved access pathways for a digital service platform can include a list of usernames and/or login accounts, a list of services that are used for multi-factor authentication, and/or a list of configured email or other contact addresses. In various embodiments, the retrieved configuration settings can include priority settings ranking different digital service platforms against one another.

At 503, authentication factors used by the digital service platforms are determined. For example, the different authentication factors used by the digital service platforms are determined. The authentication factors can include other digital service platforms such as email services or hardware token services that are used for multi-factor authentication. In various embodiments, the authentication factors can reflect dependencies between different digital service platforms. For example, an account on a first digital service platform, such as an email service, may be used to gain access to a second digital service platform, such as a customer relationship management service. As another example, an account on a third digital service platform may be used to retrieve authentication tokens used for multi-factor authentication to access a fourth digital service platform.

At 505, dependencies between the digital service platforms are determined. For example, multiple digital service platforms may be configured to rely on one another creating dependencies between different service platforms. In some embodiments, a parent digital service platform may have multiple child digital service platforms all with shared or partially shared account privileges. For example, a master administration account from a parent service may be able to have administration access to child services. In some embodiments, a digital service platform can be configured to allow other digital service platforms access to its services. For example, one or more content creation digital service platforms can be configured to access file sharing capabilities implemented by a separate and different cloud file sharing digital service platform. In some embodiments, a dependency graph can be constructed to reflect the determined dependencies between the digital service platforms.

At 507, an ordering is determined using the determined authentication factors and platform dependencies. For example, using the authentication factors determined at 503 and the digital service platform dependencies determined at 505, an ordering is determined for the different managed and/or monitored digital service platforms. The determined ordering can prioritize the services with the highest dependencies and/or the most critical dependencies. In various embodiments, the order is used for determining what order to apply remediation when a threat is detected. By determining an order for applying remediation, remediation can be applied across the different digital service platforms in an order that minimizes the impact of a detected threat.

At 509, the ordering is updated based on manual configuration settings. For example, the ordering determined at 507 is updated based on manual configurations to the ordering retrieved at 501. In some scenarios, an administrator may want to reorder and/or override the automatically determined ordering determined at 507. For example, the remediation actions may have implied costs that are not automatically extracted from the steps above, and a manual ordering may better match the desire remediation order for the digital service platforms. In some embodiments, a lower ordered digital service platform can be prioritized, or a higher prioritized platform can be deprioritized. In some embodiments, two or more platforms are set to the same priority, allowing their remediation to be performed in parallel.

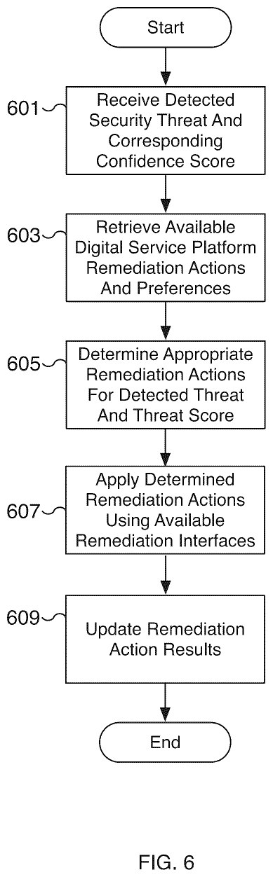

FIG. 6 is a flow chart illustrating an embodiment of a process for applying remediation for a digital service platform. For example, using the process of FIG. 6, a unified security service applies one or more remediation actions in response to a detected security threat. The remediation actions, initiated remotely by a remediation service, include initiating remediation actions and/or features supported by the digital service platform. In some embodiments, the process of FIG. 6 is performed by a unified security service such as unified security service 141 of FIG. 1 and/or the unified security service 201 of FIG. 2 at 307 and/or 309 of FIG. 3 and/or at 405 of FIG. 4. In some embodiments, the process of FIG. 6 is performed by a unified threat remediation module and/or digital service platform interface module of a unified security service such as unified threat remediation module 215 of FIG. 2 and/or digital service platform interface module 217 of FIG. 2, respectively. In some embodiments, the digital service platform that remediation is applied to is digital service platforms 131, 133, or 135.

At 601, a detected security threat and corresponding threat score is received. For example, a detected cyber security threat can be received via threat notification. The received threat notification can include one or more corresponding threat scores. For example, a threat score can include a confidence score corresponding to the likelihood the threat is an actual threat. Other threat scores can be received as well, such as severity score, an expected downtime score, a scope of impact score, a vulnerability score, a data leakage score, an operations impact score, an account exposure score, etc.

At 603, available digital service platform remediation actions and preferences are retrieved. For example, the remediation actions available for each digital service platform can be retrieved from a security service configuration data store. Additionally, digital service platform preferences such as bands or thresholds for initiating or triggering remediation are retrieved. In some embodiments, the available actions are previously configured and saved for retrieval at 603. The configured available actions can be previously automatically detected, such as by probing a digital service platform using a remediation interface, and/or can be manually configured such as by an administrator via an administration dashboard. In various embodiments, the available remediation actions and remediation preferences for each digital service platform may be different since each digital service platform can support different remediation actions and/or features and a different remediation response may be desired for different digital service platforms.

At 605, the appropriate remediation actions for the detected security threat and threat score are determined. For example, based on the detected security threat, a remediation plan including a set of remediation actions is determined for each digital service platform. The determined actions are based on the available actions retrieved at 603 for each digital service platform and the received threat score. In some embodiments, no remediation plan is created for a digital service platform based on the received threat score compared to the retrieved remediation preferences. For example, in some scenarios, no remediation plan is created since the threat score does not exceed a required threat score threshold. Based on the configured digital service platform remediation settings, different remediation actions can be configured to be triggered for different security threats only in the event that a corresponding threat score exceeds a configured threshold. In some embodiments, the remediation plan can be further based on other threat scores such as a severity score. For example, based on remediation settings, a remediation plan can be skipped for low severity threats but implemented for medium and higher severity threats. In various embodiments, the determined appropriate remediation actions for each digital service platform can and likely will differ based on the available remediation actions and configured remediation threshold triggers.

At 607, the determined remediation actions are applied using the available remediation interfaces. For example, for each digital service platform with a remediation action plan determined at 605, the corresponding remediation actions are performed for that digital service platform. The remediation actions can be initiated via a remediation interface, such as an exposed application programming interface (API) for a digital service platform. In various embodiments, a digital service platform interface module of a remediation service such as digital service platform interface module 217 of FIG. 2 of unified security service 201 of FIG. 2 implements the different remediation interfaces allowing the remediation service to interface with multiple different digital service platforms.

At 609, remediation action results are updated. For example, the results from performing remediation actions are updated to allow the remediation action results to be used for later review and/or analysis. For example, the updated results can be logged for audit purposes and the results can be updated for later access within a multiple digital service platform user interface view. In various embodiments, the up-to-date remediation action results are critical to determine whether the applied remediation actions were successful and/or to provide a current status of each digital service platform. Based on the provided current status of each digital service platform, an administrator may decide to perform additional interventions or actions such as how and when to bring full functionality back to a degraded digital service platform.

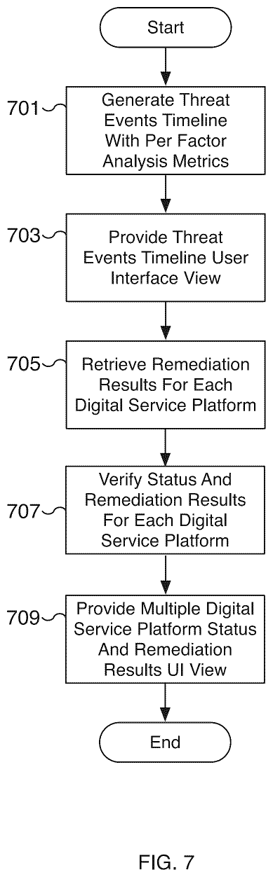

FIG. 7 is a flow chart illustrating an embodiment of a process for providing remediation user interface views for multiple digital service platforms. For example, using the process of FIG. 7, user interface views are provided that include remediation results from performing unified threat remediation across multiple different digital service platforms. The views can include event timelines and remediation results views. In some embodiments, a provided user interface view can correspond to a dashboard, one or more static views such as rendered graphics shared via email, an interactive user interface, and/or other views that display the results from performing unified threat remediation. In some embodiments, the process of FIG. 7 is performed by a unified security service such as unified security service 141 of FIG. 1 and/or the unified security service 201 of FIG. 2 at 307 and/or 309 of FIG. 3 and/or at 409 of FIG. 4. In some embodiments, the process of FIG. 7 is performed by a unified threat remediation module of a unified security service such as unified threat remediation module 215 of FIG. 2. In some embodiments, the remediation results for the digital service platforms correspond to remediation results for digital service platforms 131, 133, and/or 135.

At 701, a threat events timeline with per factor analysis metrics is generated. For example, a timeline of security threat events is generated for each digital service platform. The generated timeline can include within it different factors evaluated for each detected security threat. For example, a suspicious sign-in (or login) event can include multiple factors with corresponding analysis metrics related to the security threat assessment. Example factors and metrics can include the frequency an IP address is used, the frequency a browser type is used, and the frequency a location is used, among others. For certain factors, metrics warranting raising a cyber security threat can be highlighted and/or noted such as an IP address that has been flagged or a physical location that is rarely used to access a digital service platform. In some embodiments, the generated events timeline can include non-threat events such as events that did not rise to the level of a threat as additional context for the included threat events. In some embodiments, the threat events in the generated timeline can be linked to remediation actions performed in response to each threat event.

At 703, a threat events timeline user interface view is provided. For example, using the events timeline generated at 701, a threat timeline view that supports multiple digital service platforms is provided. For example, a threat events timeline can display each detected threat on the timeline along with the targeted digital service platform, threat event factors, and threat event factor analysis metrics. In some embodiments, the user interface view is provided via a web application such as a web dashboard. In some embodiments, the user interface view is provided via one or more rendered timeline graphics that can be delivered and/or accessed asynchronously such as via email, text message, and/or another notification or messaging system. In some embodiments, the user interface view is interactive and allows a user to drill down to view the different factors associated with each threat event and their corresponding threat event factor analysis metrics. In some embodiments, the threat events timeline user interface view can include information on the status of the platform and/or display or link to any remediation actions applied in response to the detected threat.

At 705, remediation results for each digital service platform are retrieved. For example, the results from performing any remediation actions on each digital service platform is retrieved for generating a remediation results view. The results can include results from each action performed and the time associated with each performed action. In various embodiments, different digital service platforms will have different results since different remediation actions can be applied for each digital service platform. In some embodiments, the remediation results are linked to the threat events of the threat events timeline generated at 701.

At 707, the status and remediation results for each digital service platform are verified. For example, the status of each digital service platform is checked and the remediation results retrieved at 705 are verified to ensure that information presented on the digital service platforms is current and accurate. In some embodiments, each digital service platform is queried to ensure that the status of the digital service platform is up to date and current. For example, after remediation actions are applied, additional actions including out-of-band actions may be performed that impact a digital platform service, such as restoring certain account privileges or service features. At 707, the current status is confirmed, and the remediation actions results are verified at least in part to identify any potential changes in each digital service platform since remediation was applied.

At 709, a per digital service platform status and remediation results user interface view is provided. For example, a user interface view displaying each digital service platform along with its current status and remediation actions applied is presented. In some embodiments, the user interface view presents the digital service platform status and remediation results as past remediation events. For example, the past remediation events can be ordered as a timeline and each remediation event can identify at least one digital service platform and one or more remediation actions. In some embodiments, the user interface view is provided via a web application such as a web dashboard. In some embodiments, the user interface view is provided via one or more rendered timeline graphics that can be delivered and/or accessed asynchronously such as via email, txt message, and/or another notification or messaging system. In some embodiments, the provided user interface view can include the associated threats and include additional information on the threat such as a threat assessment and associated events triggering the threat detection. In some embodiments, the provided user interface view is an interactive view that allows the user to drill down to reveal additional information, for example, on additional detail related to one or more remediation events.

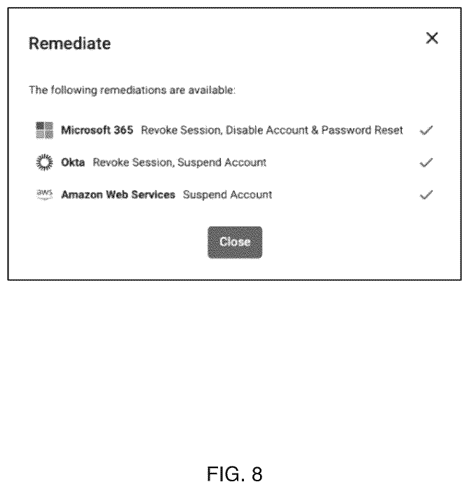

FIG. 8 is an example of a user interface view for displaying available remediation actions for different digital service platforms. The user interface view of FIG. 8 can be shown when configurating a unified security service to support unified remediation across multiple digital service platforms. As shown in FIG. 8, the remediation actions available for three different digital service platforms are displayed. In some embodiments, the available remediation actions are manually configured. in some embodiments, available remediation actions are automatically detected such as by querying a remediation interface for each digital service platform. In some embodiments, the user interface view of FIG. 8 is displayed by a unified security service at step 301 of FIG. 3. In some embodiments, the unified security service is unified security service 141 FIG. 1 and/or unified security service 201 of FIG. 2.

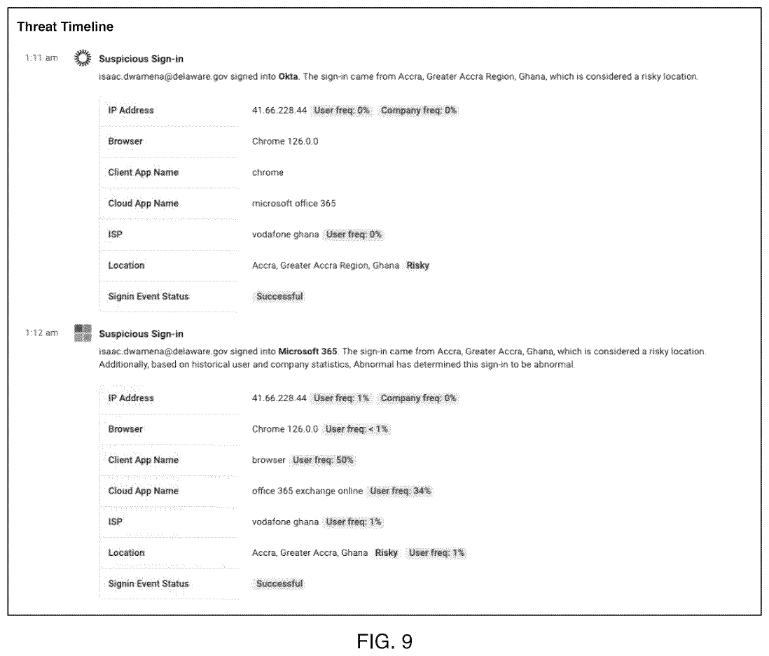

FIG. 9 is an example of a user interface view for a multiple digital service platform threat timeline. In the example shown, the displayed threat events timeline includes cyber security threats detected across multiple different digital service platforms. Each threat event is shown with its corresponding targeted digital service platform along with factors used to detect the threat and factor analysis metrics where appropriate. For example, the threat events timeline shown includes two threats, the first detected at 1:11 am for the Okta platform and a second detected at 1:12 am for the Microsoft 365 platform. Both are suspicious sign-in threat events. For the first threat event, the IP address factor is displayed with two factors: user frequency and company frequency. Both have frequency analysis metrics equal to 0% frequency. Similarly, the ISP factor shows the value “vodafone ghana” with a 0% user frequency analysis metric, and the location factor is evaluated with a “Risky” score based on the detected location in Ghana, a location never used by the associated account. Other factors are displayed as well, such as the browner, client app name, and cloud app name. Finally, the threat event shows that the suspicious sign-in was successful.

As shown in FIG. 9, the second threat event is shown for the same account but for a different digital service platform. The factors for the second threat event include IP address, browser, client app name, cloud app name, ISP, location, and sign-in event status. The factors are shown with the captured values and analysis metrics such as frequence metrics. Unlike the first threat event, the browser, client app name, and cloud app name factors include metrics for user frequency. Similar to the first threat event, the location factor of the second threat event is also considered to have a “Risky” score based on the detected location in Ghana, a location never used by the associated account. In some embodiments, the user interface view of FIG. 9 is displayed by a unified security service at step 309 of FIG. 3, at step 409 of FIG. 4, and/or at step 703 of FIG. 7. In some embodiments, the unified security service is unified security service 141 FIG. 1 and/or unified security service 201 of FIG. 2.

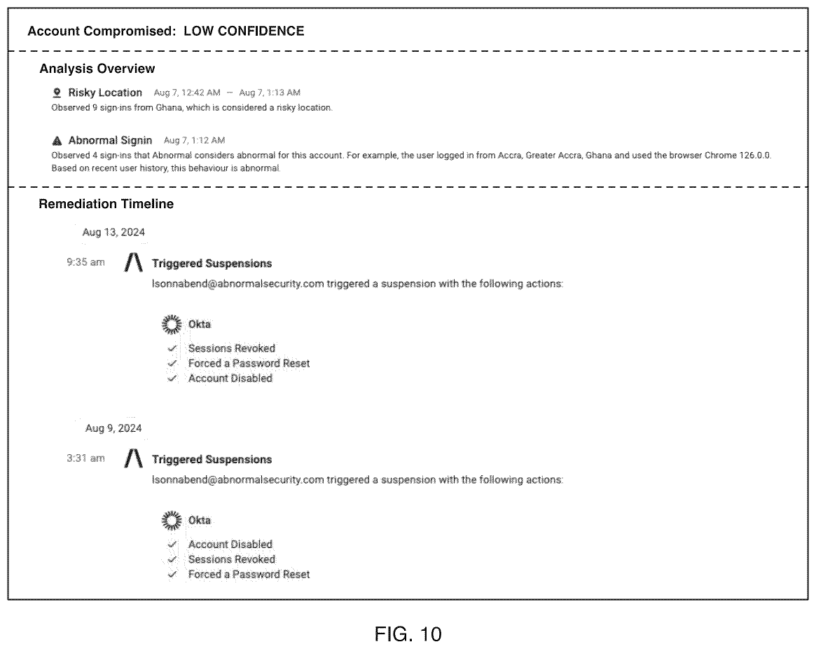

FIG. 10 is an example of a user interface view for a multiple digital service platform threat remediation timeline. In the example shown, the displayed threat remediation timeline includes an account status, a threats analysis overview, and remediation actions taken for a digital service platform. At the top of the user interface view, the status of an account for a digital service platform is shown. For the displayed account, the status of the account shows a “low confidence” with respect to the account being compromised. Displayed below the account status is an analysis overview of detected threats. In the example shown, the detected threats correspond to four abnormal sign-in events and nine sign-ins with a location considered a risky location. The bottom portion of the user interface view displays a portion of a timeline of remediation actions performed in response to detected threats. As shown, the timeline includes the two latest remediation events corresponding to two different triggered suspensions performed at different times. The earlier shown suspension was performed on Aug. 9, 2024 and resulted in remediation actions to disable the account, revoke sessions, and force a password reset. A subsequent suspension performed on Aug. 13, 2024, resulted in remediation actions to revoke sessions, force a password reset, and disable the account. In some embodiments, the user interface view of FIG. 10 is displayed by a unified security service at step 309 of FIG. 3, at step 409 of FIG. 4, and/or at step 709 of FIG. 7. In some embodiments, the unified security service is unified security service 141 FIG. 1 and/or unified security service 201 of FIG. 2.

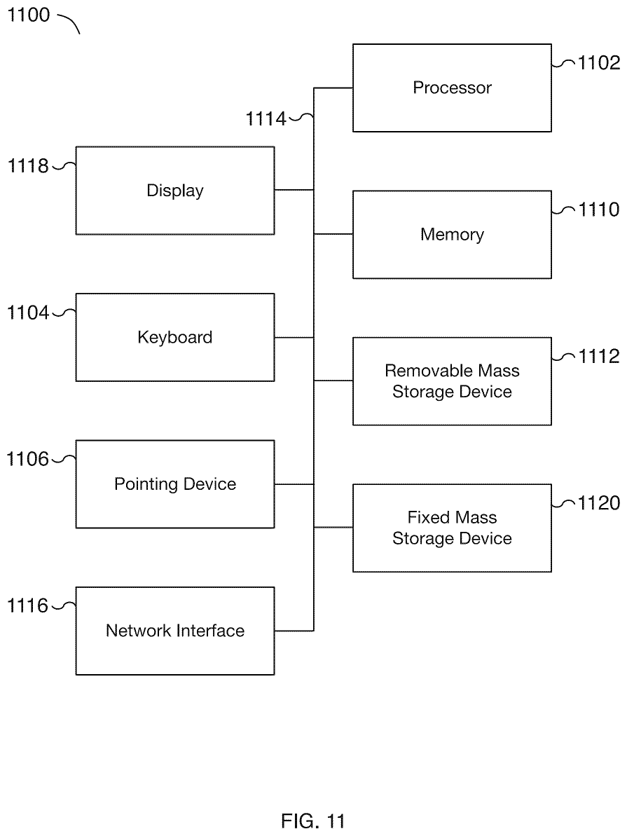

FIG. 11 is a functional diagram illustrating a programmed computer system for performing unified threat remediation. As will be apparent, other computer system architectures and configurations can be utilized for performing unified threat remediation. Examples of computer system 1100 include clients 101, 103, and 105 of FIG. 1, one or more computers of digital service platforms 131, 133, and/or 135 of FIG. 1, one or more computers of unified security service 141 of FIG. 1, and/or one or more computers of unified security service 201 of FIG. 2. Computer system 1100, which includes various subsystems as described below, includes at least one microprocessor subsystem (also referred to as a processor or a central processing unit (CPU)) 1102. For example, processor 1102 can be implemented by a single-chip processor or by multiple processors. In some embodiments, processor 1102 is a general purpose digital processor that controls the operation of the computer system 1100. Using instructions retrieved from memory 1110, the processor 1102 controls the reception and manipulation of input data, and the output and display of data on output devices (e.g., display 1118). In various embodiments, one or more instances of computer system 1100 can be used to implement at least portions of the processes of FIGS. 3-7 and the functionality associated with the diagrams of FIGS. 8-10.

Processor 1102 is coupled bi-directionally with memory 1110, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1102. Also as is well known in the art, primary storage typically includes basic operating instructions, program code, data and objects used by the processor 1102 to perform its functions (e.g., programmed instructions). For example, memory 1110 can include any suitable computer-readable storage media, described below, depending on whether, for example, data access needs to be bi-directional or unidirectional. For example, processor 1102 can also directly and very rapidly retrieve and store frequently needed data in a cache memory (not shown).

A removable mass storage device 1112 provides additional data storage capacity for the computer system 1100 and is coupled either bi-directionally (read/write) or unidirectionally (read only) to processor 1102. For example, storage 1112 can also include computer-readable media such as magnetic tape, flash memory, PC-CARDS, portable mass storage devices, holographic storage devices, and other storage devices. A fixed mass storage 1120 can also, for example, provide additional data storage capacity. The most common example of mass storage 1120 is a hard disk drive. Mass storages 1112, 1120 generally store additional programming instructions, data, and the like that typically are not in active use by the processor 1102. It will be appreciated that the information retained within mass storages 1112 and 1120 can be incorporated, if needed, in standard fashion as part of memory 1110 (e.g., RAM) as virtual memory.

In addition to providing processor 1102 access to storage subsystems, bus 1114 can also be used to provide access to other subsystems and devices. As shown, these can include a display monitor 1118, a network interface 1116, a keyboard 1104, and a pointing device 1106, as well as an auxiliary input/output device interface, a sound card, speakers, and other subsystems as needed. For example, the pointing device 1106 can be a mouse, stylus, track ball, or tablet, and is useful for interacting with a graphical user interface.

The network interface 1116 allows processor 1102 to be coupled to another computer, computer network, or telecommunications network using a network connection as shown. For example, through the network interface 1116, the processor 1102 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1102 can be used to connect the computer system 1100 to an external network and transfer data according to standard protocols. For example, various process embodiments disclosed herein can be executed on processor 1102 or can be performed across a network such as the Internet, intranet networks, or local area networks, in conjunction with a remote processor that shares a portion of the processing. Additional mass storage devices (not shown) can also be connected to processor 1102 through network interface 1116.

An auxiliary I/O device interface (not shown) can be used in conjunction with computer system 1100. The auxiliary I/O device interface can include general and customized interfaces that allow the processor 1102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above:
magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 11 is but an example of a computer system suitable for use with the various embodiments disclosed herein. Other computer systems suitable for such use can include additional or fewer subsystems. In addition, bus 1114 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
detecting a security threat associated with at least a first digital service platform for a user;
identifying a plurality of digital service platforms associated with the security threat for the user;
determining corresponding one or more remediation actions for each of the plurality of digital service platforms; and
interfacing with each of the plurality of digital service platforms via a unified security platform to perform the corresponding one or more remediation actions for at least a portion of the plurality of digital service platforms.

2. The method of claim 1, wherein the first digital service platform is an email service, a messaging service, a document creation service, a document management service, an identity service, a product management service, a cloud infrastructure service, an enterprise resource planning service, a customer relations service, or a sales management service.

3. The method of claim 1, further comprising determining available remediation actions for each of the plurality of digital service platforms.

4. The method of claim 3, where the available remediation actions include revoking a session, disabling an account, forcing a password reset, or suspending an account.

5. The method of claim 1, wherein determining the corresponding one or more remediation actions for each of the plurality of digital service platforms includes comparing a threat score of the security threat with one or more configured remediation threshold values associated with the plurality of digital service platforms.

6. The method of claim 1, further comprising providing a user interface view that includes each of the plurality of digital service platforms.

7. The method of claim 6, wherein the user interface view includes a timeline of security threat events.

8. The method of claim 6, wherein the user interface view includes one or more factors associated with the detected security threat and one or more analysis metrics for at least one of the one or more factors.

9. The method of claim 6, wherein the user interface view includes a timeline of remediation events.

10. The method of claim 9, wherein each of the remediation events identifies a corresponding digital service platform among the plurality of digital service platforms and the corresponding one or more remediation actions for the corresponding digital service platform.

11. A system, comprising:
one or more processors; and
a memory coupled to the one or more processors, wherein the memory is configured to provide the one or more processors with instructions which when executed cause the one or more processors to:
detect a security threat associated with at least a first digital service platform for a user;
identify a plurality of digital service platforms associated with the security threat for the user;
determine corresponding one or more remediation actions for each of the plurality of digital service platforms; and
interface with each of the plurality of digital service platforms via a unified security platform to perform the corresponding one or more remediation actions for at least a portion of the plurality of digital service platforms.

12. The system of claim 11, wherein the first digital service platform is an email service, a document creation service, a document management service, an identity service, a product management service, a customer relations service, or a sales management service.

13. The system of claim 11, wherein the memory is further configured to provide the one or more processors with instructions which when executed cause the one or more processors to: determine available remediation actions for each of the plurality of digital service platforms.

14. The system of claim 13, where the available remediation actions include revoking a session, disabling an account, forcing a password reset, or suspending an account.

15. The system of claim 11, wherein determining the corresponding one or more remediation actions for each of the plurality of digital service platforms includes comparing a threat score of the security threat with one or more configured remediation threshold values associated with the plurality of digital service platforms.

16. The system of claim 11, wherein the memory is further configured to provide the one or more processors with instructions which when executed cause the one or more processors to: provide a user interface view that includes each of the plurality of digital service platforms.

17. The system of claim 16, wherein the user interface view includes a timeline of security threat events.

18. The system of claim 16, wherein the user interface view includes one or more factors associated with the detected security threat and one or more analysis metrics for at least one of the one or more factors.

19. The system of claim 16, wherein the user interface view includes a timeline of remediation events, wherein each of the remediation events identifies a corresponding digital service platform among the plurality of digital service platforms and the corresponding one or more remediation actions for the corresponding digital service platform.

20. A computer program product, the computer program product being embodied in a non-transitory computer readable storage medium and comprising computer instructions for:
detecting a security threat associated with at least a first digital service platform for a user;
identifying a plurality of digital service platforms associated with the security threat for the user;
determining corresponding one or more remediation actions for each of the plurality of digital service platforms; and
interfacing with each of the plurality of digital service platforms via a unified security platform to perform the corresponding one or more remediation actions for at least a portion of the plurality of digital service platforms.
